(19) United States
(12) Patent Application Publication
(10) Pub. No.: US 2009/0219150 A1
(43) Pub. Date: Sep. 3, 2009

(54) High-Visibility Hazard Flasher

(75) Inventor: John W. DeYoung, Lynden, WA (US)

Correspondence Address: John W. DeYoung, 318 Kwanzan Drive, Lynden, WA, 98264-9542, US

(73) Assignee: John Winston DeYoung, Lynden, WA (US)

(21) Appl. No.: 12/072,983

(22) Filed: Feb. 28, 2008

(51) Int. Cl. B60Q 1/52

(52) U.S. Cl. 340/471

(57) ABSTRACT

The automotive hazard flashers described make more usable the distinctive, high-visibility flash hazard signal of U.S. Pat. No. 6,515,584 B2. That signal is here made available, at the driver's selection, as an auxiliary alternative hazard signal to a standard hazard signal. Both signals are displayed in a vehicle's turn signal lamps. The auxiliary high-visibility hazard signal may also be displayed in supplementary lamps. Automatic cancellation of hazard signals by activating a turn signal is made available. The use of one distinctive, high-visibility hazard signal, such as that of U.S. Pat. No. 6,515,584 B2, is made available as a single, consistent warning signal for different types of hazards, including manually signaled hazard warnings, vehicle-in-reverse warning and rapid deceleration warning.

### REFERENCES

U.S. Pat. No. 6,515,584 B2 Feb. 2003 DeYoung

U.S. Pat. No. 6,842,111 January 2005 Smithson

### FEDERALLY SPONSORED RESEARCH AND DEVELOPMENT

### None

### BACKGROUND OF THE INVENTION

My U.S. Pat. No. 6,515,584 B2 provides for a motor vehicle flasher, which produces a hazard warning signal that is easily and quickly distinguished from a turn signal, and which is more highly visible than a standard hazard signal. Said flasher can be programmed to produce any flash rate desired, but it is intended to produce a flash of 150 to 250 flashes per minute. Federal Motor Vehicle Safety Standards (FMVSS) require that a hazard flasher produce a signal of 60 to 120 flashes per minute. The faster, pulsating flash hazard signal described by my said patent is more highly visible and more attention getting than such a standard hazard signal. My said patent provides for a flasher unit that produces only one hazard flash rate and pattern. It seems desirable to make available a flasher which can produce signals with a hazard flash rate and pattern which meet the federal requirement and in addition produces, as an auxiliary hazard signal, the signal envisioned by my said patent, which provides a more effective hazard alert, because it is more highly visible and is distinctive in comparison with a turn signal. Turn signal flashes are ubiquitous and not interpreted by drivers as signaling a hazard. Turn-signal-like hazard flashes are likewise not easily recognized as signaling a potentially more significant hazard. In large trucks, hazard signals are mechanically canceled when a turn signal is activated. The cancellation is by means of the conventional combination turn/hazard signal switch used in such trucks. Hazard signal cancellation by activation of a turn signal would be a desirable feature for all vehicles. Such cancellation should be very useful for buses and delivery vehicles, which use their hazard signals many times a day. U.S. Pat. No. 6,842,111 provides for turn signal cancellation of an auxiliary hazard signal attachment but not for hazard signals in turn signal lamps.

There are many different hazard-warning signals used on vehicles. There are patents providing for a variety of flashes, for many kinds of flashing lamps and for signals for specific hazards. It seems desirable to use one convenient, consistent, effective, simple flasher signal for as many types of hazards as possible.

### BRIEF SUMMARY OF THE INVENTION

This invention consists of additions, improvements and applications to the flasher described in my U.S. Pat. No. 6,515,584 B. The flasher described in that patent provides for use in vehicles a specific hazard flash signal (hereinafter “High-Visibility Flash”) displayed in the vehicle's turn signal lamps, which signal is rapid, pulsating, of high visibility, and distinctive from standard turn signals.

The features claimed herein are for use in all types of vehicles including those pulling trailers. This invention provides for:
A flasher that allows the vehicle operator to select to display in the vehicle's turn signal lamps either of two different hazard signals:
   A standard turn-signal-like hazard signal, which complies with FMVSS;
   An auxiliary High-Visibility Flash hazard signal, which is more effective than a standard hazard signal.
A flasher that automatically cancels the hazard signal displayed in the vehicle's turn signal lamps when a turn signal is activated.
A flasher that automatically produces a hazard signal in the vehicle's turn signal lamps while the vehicle is in reverse gear.
A flasher that automatically produces a hazard signal in the vehicle's turn signal lamps when the vehicle decelerates very rapidly.
A flasher that produces the same consistent, recognizable, auxiliary High-Visibility Flash for the following three different types of hazard alert:
   A hazard signal manually engaged by the vehicle operator;
   An automatically triggered signal that the vehicle is in reverse gear;
   An automatically triggered signal that the vehicle is decelerating very rapidly.
A flasher, which provides for supplementary flasher lamps that do not display turn signals or standard hazard signals but do display an auxiliary High-Visibility Flash hazard signal synchronously with turn signal lamps, to achieve greater visibility than an auxiliary High-Visibility Flash hazard signal would achieve in turn signal lamps alone. The supplementary lamps can be permanently attached to a vehicle or can be temporary lamps, which are plugged in and attached where needed on a vehicle or a towed unit.

### BRIEF DESCRIPTION OF THE DRAWINGS

FIG. 1 is a block diagram of flasher unit Version B showing the flasher application.

FIG. 2 is a block diagram of flasher unit Version C showing the flasher application.

FIG. 3 is a block diagram of flasher unit Version D showing the flasher application.

FIG. 4 is a block diagram of flasher unit Version E showing the flasher application.

FIG. 5 is a schematic of flasher unit Version B.

FIG. 6 is a schematic of flasher unit Version C.

FIG. 7 is a schematic of flasher unit Version D.

### DETAILED DESCRIPTION OF THE INVENTION

The flashers described herein provide the means to produce, in a vehicle's turn signal lamps, a consistent, recognizable hazard-flash pattern for multiple situations. At present, Federal Motor Vehicle Safety Standards (FMVSS) require all such hazard flashers to flash at a rate of 60 to 120 flashes per minute, the same as for turn signals. In effect, all hazard flashers use the same signal as is used for turn signals. In our devices, except for our original flasher, we make available a conventional turn signal type hazard flash to meet the regulatory requirement, but we also provide the option, as an auxiliary signal, in the vehicle's turn signal lamps, the highly visible, highly effective hazard-alert flash described in U.S. Pat. No. 6,515,584 B2 (hereinafter “High-Visibility”) Flash, which is a very distinctive signal in comparison to a turn signal flash. Wide usage of our flashers would help drivers more effectively alert other drivers to hazards and should make a meaningful contribution to safety. Some situations where the auxiliary High-Visibility Flash hazard signal made available with our flashers would be an improvement over current practice are:
Automatically-triggered signals that a vehicle is in reverse;
Automatically-triggered signals that a vehicle is rapidly decelerating;
Hazard alerts signaled by the driver such as:
   Any vehicle signaling a hazard while the turn signal lamp on one side of the vehicle is obscured, so that other drivers would be unable to discern whether a standard hazard signal in the single turn signal lamp which is within their view signals a turn or a hazard, whereas our auxiliary High-Visibility Flash hazard signal would very easily be interpreted as signaling a hazard.
   City buses stopped at the curb with High-Visibility Flash hazard signal on; the hazard signal to be automatically canceled when the driver activates a turn signal upon being ready to pull into traffic;
   Delivery trucks stopped for deliveries with High-Visibility Flash hazard signal on; the hazard signal to be automatically canceled when the driver activates a turn signal upon being ready to pull into traffic;
   Big trucks moving up steep hills in slow traffic lanes with High-Visibility Flash hazard signal on; the hazard signal to be automatically canceled when the driver activates a turn signal upon being ready to pull into traffic;
   Trucks stopped for railroad tracks with High-Visibility Flash hazard signal on; the hazard signal to be automatically canceled when the driver activates a turn signal upon being ready to pull into traffic;
   Garbage trucks stopping to collect garbage with High-Visibility Flash hazard signal on; the hazard signal to be automatically canceled when the driver activates a turn signal upon being ready to pull into traffic;
   Mail delivery vehicles;
   Trucks which use manually triggered hazard signals to signal they are backing;
   Service vehicles for municipalities and utility companies;
   Any vehicle moving slowly for any reason,
   Warning to other drivers of a hazard on the road such as an accident or stopped traffic while approaching, overtaking or passing such hazard;
   Vehicles driving in poor visibility conditions, such as fog, snow, or dust;
   Trucks and other slow-accelerating vehicles when pulling into fast-moving traffic.

There are five versions of the flasher, which are referred to here as Flasher Unit Versions A, B, C, D and E. All five versions incorporate the rapid, pulsating hazard flash signal described in my U.S. Pat. No. 6,515,584 B2.

FLASHER UNIT VERSION A is the unit described in my U.S. Pat. No. 6,515,584 B2. Version A is intended to be the sole flasher for a vehicle. Version A provides the standard turn signal, but does not produce the standard hazard signal. Version A produces the Auxiliary High-Visibility flash when both left and right turn signal lamps are activated and the turn signal flash when only one side's lamps are activated.

FLASHER UNIT VERSION B is a modification of Version A. Version B is intended to be the sole flasher for a vehicle. Version B provides for the selection by the driver of either the standard hazard signal or, as an auxiliary hazard signal, the High-Visibility Flash. Both types of hazard signals are displayed in the vehicle's turn signal lamps.

FLASHER UNIT VERSION C provides additional features and uses a different sensing approach from Versions A and B. Version C is intended to be the sole flasher for a vehicle. It produces turn signals and standard rate hazard signals. In addition, it can produce, in a vehicle's turn signal lamps, the auxiliary High-Visibility Flash in any of these three applications:
An auxiliary High-Visibility Flash hazard signal selected manually by the driver;
An automatically-triggered auxiliary High-Visibility Flash hazard signal that the vehicle is in reverse gear;
An automatically-triggered auxiliary High-Visibility Flash hazard signal that the vehicle is decelerating more rapidly than a preset deceleration rate.

Version C cancels the auxiliary High-Visibility Flash hazard signal when a left or right turn signal is activated or when the standard rate hazard signals are activated, i.e., the turn signal switch and standard hazard signal switch act as shutoff switches for the auxiliary High-Visibility Flash hazard signal.

FLASHER UNIT VERSION D is not intended to be the sole flasher for a vehicle. Version D provides the auxiliary High-Visibility Flash in the turn lamps as an auxiliary hazard signal but does not produce turn signals or the standard hazard signal. These signals are provided by the vehicle's original equipment standard turn and hazard signal systems. Version D can produce, in a vehicle's turn signal lamps, the auxiliary High-Visibility Flash in any of these three applications:
An auxiliary High-Visibility Flash hazard signal selected manually by the driver;
An automatically-triggered auxiliary High-Visibility Flash hazard signal that the vehicle is in reverse gear;
An automatically-triggered auxiliary High-Visibility Flash hazard signal that the vehicle is decelerating more rapidly than a preset deceleration rate.

Version D cancels the auxiliary High-Visibility Flash hazard signal when a left or right turn signal is activated or when the standard rate hazard signals are activated, i.e., the turn signal switch and standard hazard signal switch act as shutoff switches for the auxiliary High-Visibility Flash hazard signal.

FLASHER UNIT VERSION E is identical to Version D with one addition: it produces the auxiliary High-Visibility Flash hazard signals in supplemental flasher lamps, i.e., lamps other than turn signal lamps, synchronously with the auxiliary High-Visibility Flash hazard signal in the turn signal lamps.

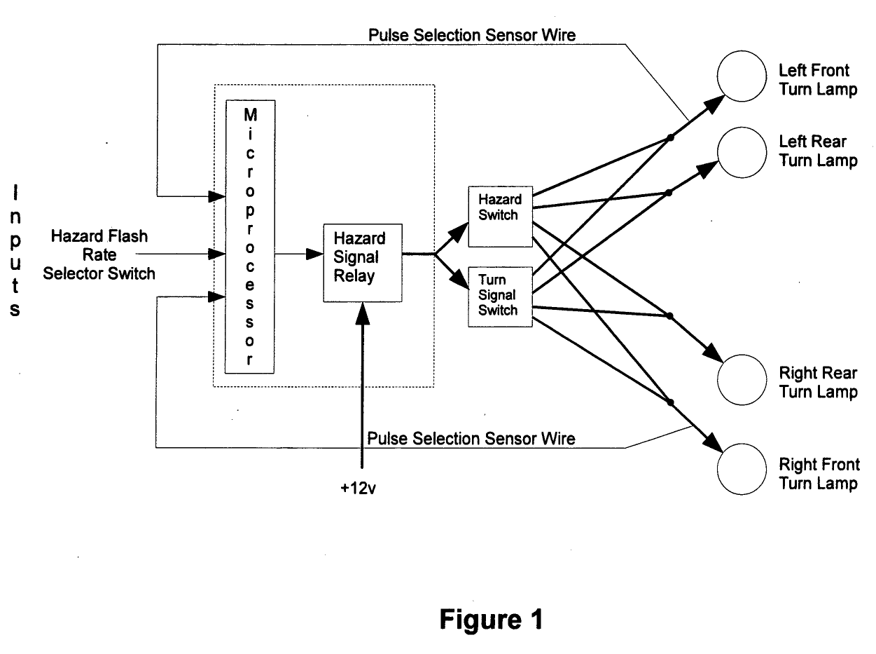

### FIG. 1—Flasher Unit Version B

Version B includes a switch for the operator to select either the auxiliary High-Visibility Flash hazard signal or the standard flash hazard signal. Both auxiliary High-Visibility Flash hazard signals and standard hazard signals are routed to the vehicle's turn signal lamps via its hazard signal switch.

When the Hazard Flash Rate Selector Switch is open and the Hazard Switch is closed, a standard hazard flash is produced.

When the Hazard Flash Rate Selector Switch is closed, to provide for an auxiliary High-Visibility Flash hazard signal, and the Hazard Switch is closed, the external Pulse Selection Sensor Wires inform the microprocessor that the lamps on both left and right sides are operating, causing the auxiliary High-Visibility Flash to be produced.

When the Hazard Flash Rate Selector Switch is closed, to enable an auxiliary High-Visibility Flash hazard signal, while the Hazard Switch is open, and the turn signal switch is closed to provide a left or right turn signal, the external Pulse Selection Sensor Wires inform the microprocessor that the lamps on only one side are operating, causing a turn signal flash to be produced and not an auxiliary High-Visibility flash.

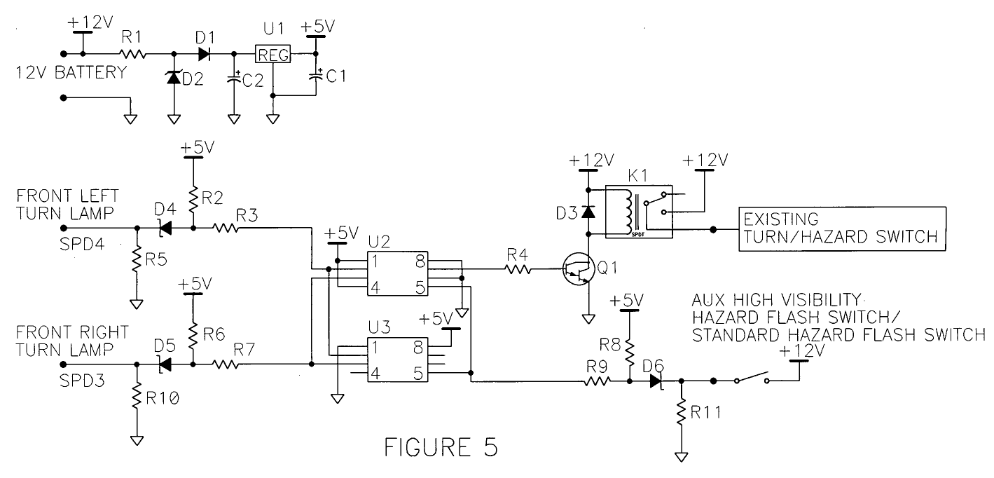

### FIG. 5—Flasher Unit Version B

The Flasher Unit Version B is designed around a single chip 8-bit microprocessor. The processor used in the prototype is a Microchip PIC12C508 microprocessor. However, there are other 8-bit processors that could be used for this purpose. Pin connections to the microprocessor (uP) are as follows:

| Signal Name | uP Pin | I/O | Function |
|---|---|---|---|
| Vcc | 1 | Power | +5 Volts to uP |
| LFrontIn | 2 | Input | Left Turn signal input |
| RFrontIn | 3 | Input | Right Turn signal input |
| unused | 4 | I/O | Unused pin |
| HiVizStd | 5 | Input | Hi Visibility/Std hazard flash input |
| unused | 6 | I/O | Unused pin |
| FlashDrvOut | 7 | Output | Flash drive output |
| Vss | 8 | Power | Ground to uP |

The uP performs logic operations based on time to create the flashing output from the Flasher Unit.

For the purposes of a prototype design, the High-Visibility Flash output is a series of flashes as follows: On 175 ms, off 200 ms, on 175 ms, off 200 ms, on 175 ms, off 750 ms, then repeating. This sequence may be any other combination of repeating or non-repeating flashes.

The unit is activated when power is applied to the circuit at the 12V battery input. Power is thus applied to the microprocessor, which activates, goes through its reset routine and then goes to a standby state until either a Right Turn (RFrontIn) a Left Turn (LFrontIn) or hazard (both RFrontIn and LFrontIn simultaneously) signal is received by the uP. If either a RFrontIn or LFrontIn, but not both is received the uP proceeds with a Standard turn signal program of activating and deactivating the lamp drive output (FlashDrvOut). The FlashDrvOut (Flash drive output) signal is fed to the base of transistor Q1 through current limiting resistor R4. When current is applied to the base of Q1, the collector of Q1 is pulled to ground potential and the flasher lamp is energized through K1. The unit continues to drive the flasher lamp until the unit is deactivated by turning the activating signal off. If both the RFrontIn and the LFrontIn signals are received, the uP outputs the High-Visibility program of flashing lights, only if the HighVizStd switch is closed. If the HighVizStd switch is open, the uP will output the Standard turn signal program.

Protective circuitry is supplied for all signal inputs. The LFrontIn signal input will be described. All other input circuits are identical. R5 helps bias the input low when the input is fed from an LED light array. Without R5, the input is not pulled low properly when the LED array is turned off. D4 blocks the 12V lamp voltage from getting to the uP. The uP operates on 5 Volts. When the Left Turn Lamp is turned on, SPD4 goes to 12V. R2 pulls the anode of D4 to 5 Volts. R3 is a current limiting resistor to protect the uP input (pin 2). If a transient signal of high voltage is detected at the LFrontIn input, it is current limited by R3 and clamped by U3 Pin2 (TL7726) to the power rails.

The power supply circuit is described. Battery power is connected to the circuit between ground (−) and one end of R1. The other end of R1 is connected to the anode of D2 and the cathode of D1. D2 operates along with the forward biased D1 to protect against reverse polarity. D2 in the reverse biased mode operates to limit the total voltage input to U1 to about 20 Volts for transients. C2 provides filtering for the input current. U1 is a three terminal regulator that regulates the input voltage (+9 to +16 Volts) to +5 Volts. The +5 Volts is supplied to all points in the circuit requiring +5 Volts. C1 is an output filter for the +5 Volts.

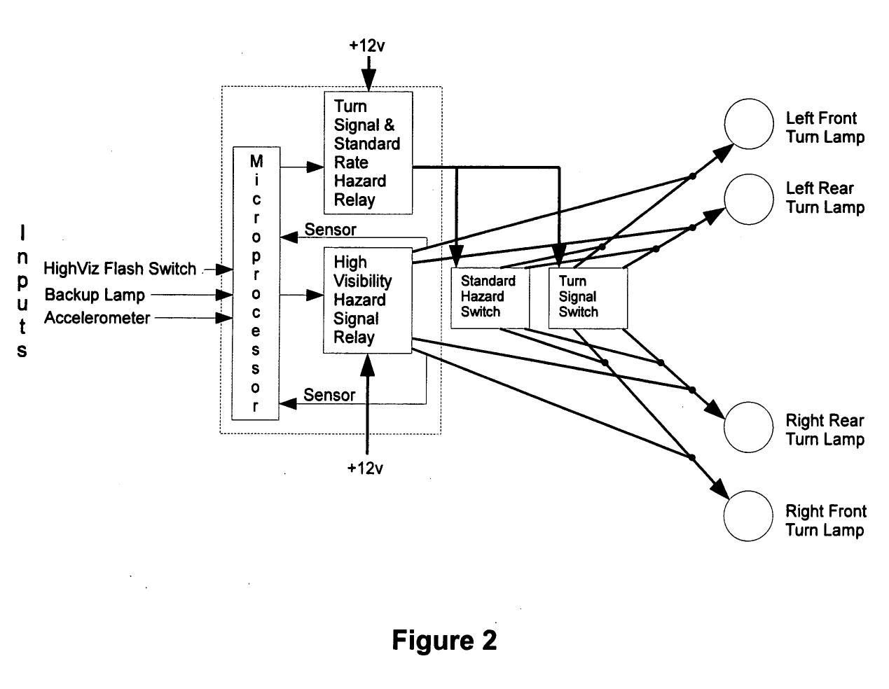

### FIG. 2—Flasher Unit Version C

This unit provides three separate flash outputs, all displayed in the vehicle's turn signal lamps: 1) Turn signals, 2) Standard rate hazard signals, and 3) Auxiliary High-Visibility Flash hazard signals. The standard rate hazard signal will usually be the same rate as the turn signal, but it can be programmed to be different.

The Turn Signal & Standard Rate Hazard Relay begins in the closed position. If the Turn Signal Switch is closed to the left or right turn signal position, the relay will begin to open and close at the programmed rate for turn signal flashes and the left or right lamps will produce a turn signal. If the Standard Hazard Switch is closed, the relay will begin to open and close at the programmed rate for standard hazard signal flashes, and all turn signal lamps will produce the standard rate hazard signal.

The High-Visibility Hazard Signal Relay begins in the open position. The relay will begin to open and close at the programmed rate and pattern for High-Visibility Flashes if one of the following occurs:
1. The HighViz Flash Switch Input is triggered by the operator pushing a momentary switch;
2. The Backup Lamp Input is triggered automatically while the vehicle is in reverse gear;
3. The Accelerometer Input is triggered automatically when the vehicle decelerates more rapidly than the accelerometer's preset deceleration rate.

The High-Visibility Flash is conducted via direct wiring to all turn signal lamps, which produce the auxiliary-High-Visibility Flash hazard signal.

If, while an auxiliary High-Visibility Flash is being generated, the microprocessor is informed, via the internal Sensor connections, that the lamps are receiving a flash rate different from the auxiliary High-Visibility Flash rate, which will occur when a turn signal or standard rate hazard is signaled, the auxiliary High-Visibility hazard flash will be canceled.

A standard hazard signal will be canceled by activation of a turn signal only if the standard hazard signal is programmed to flash at a slower or faster rate than the rate at which the turn signal is programmed.

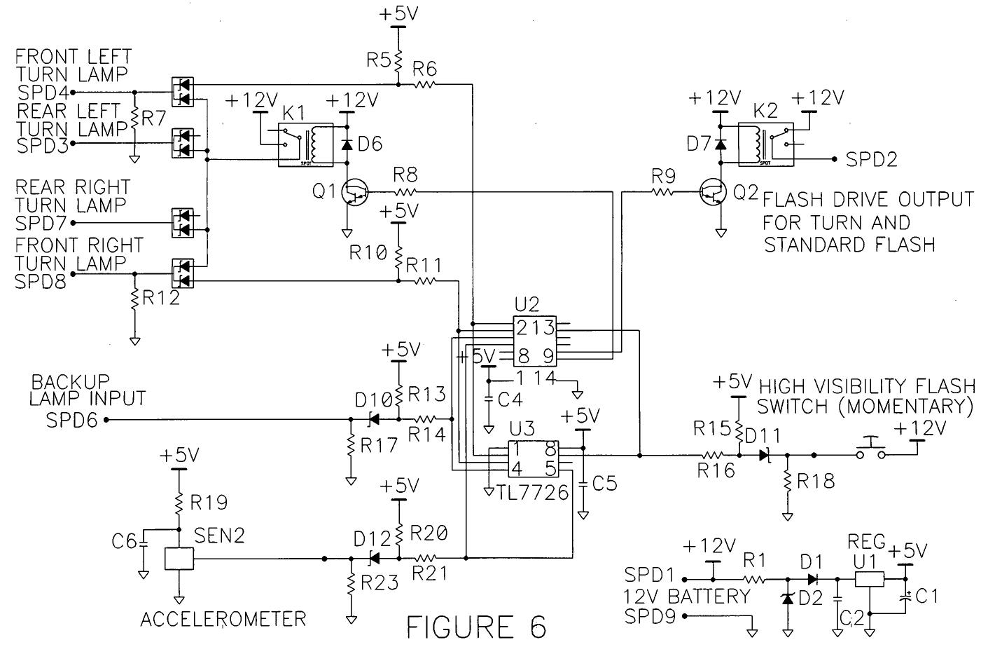

### FIG. 6—Flasher Unit Version C

The Flasher Unit Version C is designed around a single chip 8-bit microprocessor. The processor used in this implementation is a Microchip PIC16F505 microprocessor. However, there are other 8-bit processors that could be used for this purpose. Pin connections to the microprocessor (uP) are as follows:

| Signal Name | uP Pin | I/O | Function |
|---|---|---|---|
| Vdd | 1 | Power | +5 Volts to uP |
| LFrontInOut | 2 | Input | Lt front lamp input & Lt lamp |
| | | | output |
| RFrontInOut | 3 | Input | Rt front lamp input & Rt lamp |
| | | | output |
| BackLampIn | 4 | Input | Backup lamp input |
| AccelerometerIn | 5 | Input | Accelerometer input |
| Not used | 6 | — | Unused pin |
| Not used | 7 | — | Unused pin |
| HiVizDrOut | 8 | Output | High-Visibility flash drive output |
| STDDrOut | 9 | Output | Standard Flash drive output |
| Not Used | 10 | — | Unused pin |
| STDSwIn | 11 | Input | Standard hazard flash switch input |
| HiVizSwIn | 12 | Input | High-Visibility hazard flash |
| | | | switch input |
| Not used | 13 | — | Unused pin |
| Vss | 14 | Power | Ground to uP |

The uP performs logic operations based on time to create the flashing outputs from the Flasher Unit.

For the purposes of a prototype design, the High-Visibility Flash rate is a series of flashes as follows: On 166 ms, off 200 ms, on 166 ms, off 200 ms, on 166 ms, off 200 ms, on 166 ms, off 466 ms, then repeating. This sequence may be any other combination of repeating or non-repeating flashes. The Standard Flash rate is 333 ms on followed by 333 ms off, then repeating.

The unit is activated when power is applied to the circuit at the 12V battery input. Power is thus applied through the Power Regulator to the microprocessor (uP), which activates, goes through its reset routine and then goes to a standby state until either a Right Turn (RFrontIn), a Left Turn (LfrontIn), a Backup Lamp activation, or High-Visibility flash switch is detected by the uP. In the standby state SPD2 is high at +12VDC. If either the right or left turn signal switch or the standard hazard switch is activated, the input signal to the uP goes high to +5VDC. The uP proceeds with a Standard turn signal program of de-activating and activating the lamp drive output (STDDrOut). When the STDDrOut signal is low, SPD2 is high. When the STDDrOut signal is high, SPD2 is low. When a high STDDrOut signal is applied to the base of Q2, a Darlington transistor, the collector of Q2 is pulled to ground potential and the flasher relay is energized, making SPD2 low and the lamp is off. R9 limits the base drive current to Q2 to about 1 ma. D7 reduces the EMI from the relay when it de-energizes.

If the Standard hazard flash switch is pushed on, the unit will go into the Standard hazard flash function. K2 is activated by Q2 and connects all lamps to SPD2 through the Existing Standard Hazard Flash Switch to make them act in concert.

If the High-Visibility hazard flash switch is momentarily pushed, the unit will go into the High-Visibility hazard flash function. K1 is activated by Q1 and connects to all lamps through the D4, D5, D8 and D9 diodes to make them act in concert. At any time the High-Visibility hazard flash function may be cancelled by turning on either turn signal or the standard hazard signal or by momentarily pushing the High-Visibility hazard flash switch.

If the Backup lights are turned on, all lamps will flash at the High-Visibility rate. If the turn signal is turned on, the High-Visibility hazard flash will be turned off. When the turn signal is then turned off and the Backup lights are still on, all lamps will again flash at the High-Visibility rate until the backup lamps are turned off. If the High-Visibility flash switch is pushed, the High-Visibility flash function will be terminated.

The Accelerometer is included to detect rapid deceleration in case of accident or any emergency stop. If activated, the sudden acceleration will cause the High-Visibility flash rate function to be started. When the High-Visibility flash switch is subsequently pushed, the High-Visibility flash function will be terminated.

Protective circuitry is supplied for all signal inputs. The LfrontIn signal input will be described. All other input circuits are identical. R7 helps bias the uP input low when the input is fed from an LED light array. Without R7, the input will not be pulled low properly when the LED array is turned off. D4 (pins 2 & 3) blocks the +12V lamp voltage from getting to the uP. The uP operates on +5 Volts. When the Left Turn Lamp is turned on, SPD4 goes to +12V. R5 pulls the anode of D4 (pins 1 & 2) to +5 Volts. If a transient signal of high voltage is detected on the +5 Volts, it is clamped by U3 pin 2. U3 is a TL7726 is a hex clamping circuit.

The Power Regulator circuit is described. Battery power is connected to the circuit between ground (−) and one end of D1. The other end of D1 is connected to U1 (+5V regulator). D1 is present to provide polarity protection for the entire circuit. If the power connections are reversed, no current can flow to the circuit since D1 is reverse biased. D2 provides over voltage and more polarity protection. C1 provides filtering for the input current. U1 is a three terminal regulator that regulates the input voltage (+9 to +16 Volts) to +5 Volts. The +5 Volts is supplied to all points in the circuit requiring +5 Volts. C2 is an output filter for the +5 Volts.

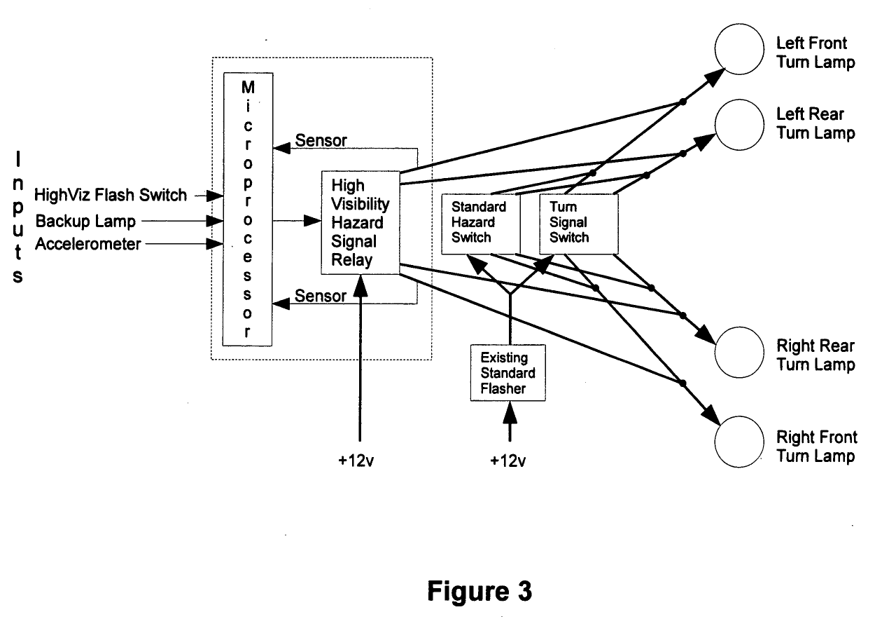

### FIG. 3—Flasher Unit Version D

This unit displays auxiliary High-Visibility Flash hazard signals in the vehicle's turn signal lamps. Version D does not produce turn signals or standard rate hazard signals.

The Existing Standard Flasher generates the standard flash whenever the Turn Signal Switch is closed to the left or right turn signal position is closed or when The Standard Hazard Switch is closed. In aftermarket application, Version D relies on the original equipment to provide turn and standard hazard signals.

The High-Visibility Hazard Signal Relay begins in the open position. The relay will begin to open and close at the programmed rate and pattern for auxiliary High-Visibility Flashes if one of the following occurs:
1. The HighViz Flash Switch Input is triggered by the operator pushing a momentary switch;
2. The Backup Lamp Input is triggered automatically while the vehicle is in reverse gear;
3. The Accelerometer Input is triggered automatically when the vehicle decelerates more rapidly than the accelerometer's preset deceleration rate.

The auxiliary High-Visibility Flash signal is conducted via direct wiring to all turn signal lamps, which produce the auxiliary High-Visibility Flash hazard signal.

The auxiliary High-Visibility hazard flash will be canceled if, the microprocessor is informed, via the internal Sensor connections, that the lamps are receiving a flash rate different from the auxiliary High-Visibility Flash rate, which different flash rate will occur when a turn signal or standard rate hazard is signaled,

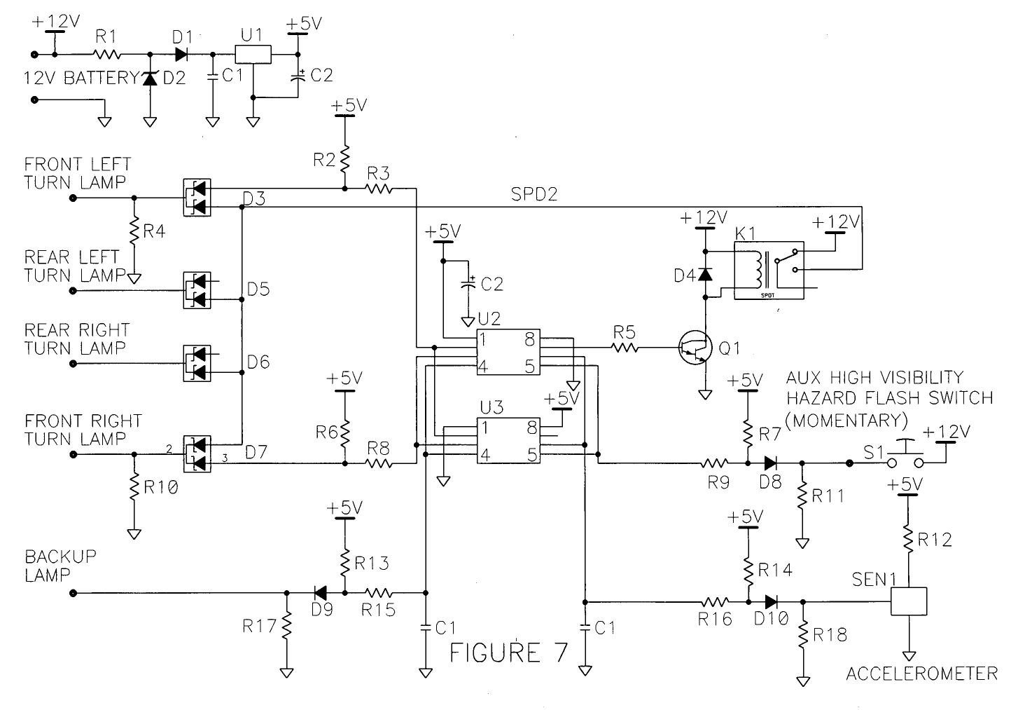

### FIG. 7—Flasher Unit Version D

The Flasher Unit Version D is designed around a single chip 8-bit microprocessor. The processor used in this implementation is a Microchip PIC16F509 microprocessor U2. However, there are dozens of other 8-bit processors that could be used for this purpose. Pin connections to the microprocessor (uP) are as follows:

| Signal Name | uP Pin | I/O | Function |
|---|---|---|---|
| Vdd | 1 | Power | +5 Volts to uP |
| LFrontIn | 2 | Input | Left front lamp input |
| RFrontIn | 3 | Input | Right front lamp input |
| BackLampIn | 4 | Input | Backup lamp input |
| AHFIn | 5 | Input | Auxiliary Hazard Flash |
| | | | switch input |
| Accelerometer In | 6 | Input | Accelerometer input |
| FlashDrvOut | 7 | Output | Flash Drive output |
| Vss | 8 | Power | Ground to uP |

The uP performs logic operations based on time to create a flashing output from the Auxiliary Hazard Flash Unit.

For the purposes of a prototype design, the Auxiliary Hazard Flash Unit rate is a series of flashes as follows: On 75 ms, off 150 ms, on 75 ms, off 150 ms, on 75 ms, off 150 ms, on 75 ms, off 525 ms, then repeating. This sequence may be any other combination of repeating or non-repeating flashes. For reference, the Standard Turn Signal Flash Rate is approximately 333 ms on followed by 333 ms off, then repeating.

The unit is activated when power is applied to the circuit at the 12V battery input. Power is thus applied through the Power Regulator to the microprocessor (uP), which activates, goes through its reset routine and then goes to a standby state until either the Auxiliary Hazard Flash switch is pushed momentarily or the backup lights are turned on by putting the vehicle into reverse gear. At this point in time, the uP begins to output the High-Visibility Flash rate. The unit will output the High-Visibility Flash rate until either:
1. The Auxiliary Hazard Flash switch is pushed again momentarily.
2. The backup Lamps are turned off.
3. Either turn signal (right or left) is activated.
4. The on-board standard hazard flash unit is activated.

If any of these conditions are met, the Auxiliary Hazard Flash Unit will deactivate and the uP will return to the standby state.

The Accelerometer is included to detect rapid deceleration in case of accident or any emergency stop. If activated, the sudden acceleration will cause the High-Visibility flash rate function to be started. When the High-Visibility flash switch is subsequently pushed, the High-Visibility flash function will be terminated.

The K1 relay drive circuit is described. When the FlashDrvOut signal is low, SPD2 is low. When the FlashDrvOut signal is high, SPD2 is high. When a high FlashDrvOut signal is applied to the base of Q1, a Darlington transistor, the collector of Q1 is pulled to ground potential and the flasher relay (K1) is energized, making SPD2 high. R5 limits the base drive current to Q1 to about 1 ma. D4 reduces the EMI from the relay when it de-energizes. SPD2 is also fed through one half of D3, D5, D6 and D7 to drive all lamps.

Protective circuitry is supplied for all signal inputs. The LFrontIn signal will be described. All other input circuits are identical. R4 helps bias the uP input low when the input is fed from an LED light array. Without R4, the input will not be pulled low properly when the LED array is turned off. Half of D3 (pins 2 & 3) blocks the +12V lamp voltage from getting to the uP. The uP operates on +5 Volts. When the Left Turn Lamp is turned on, LFrontIn signal input goes to +12V. R2 pulls the upper anode of D3 to +5 Volts. If a transient signal of high voltage is detected on the +5 Volts, it is clamped by CL1 of U3 (TL7726), a 5.0VDC bi-directional clamp.

The Power Regulator circuit is described. Battery power is connected to the circuit between ground (−) and the cathode of D2 through current limiting resistor R1. D2 and R1 provide the first tier of polarity protection for the entire circuit. The cathode end of D2 is connected to the input of U1 through D1. D1 is present to provide a second tier of polarity protection for the entire circuit. If the power connections are reversed, no current can flow to the circuit since D1 is reverse biased. C1 provides filtering for the input current. U1 is a three terminal regulator that regulates the input voltage (+9 to +16 Volts) to +5 Volts. The +5 Volts is supplied to all points in the circuit requiring +5 Volts. C2 is an output filter for the +5 Volts.

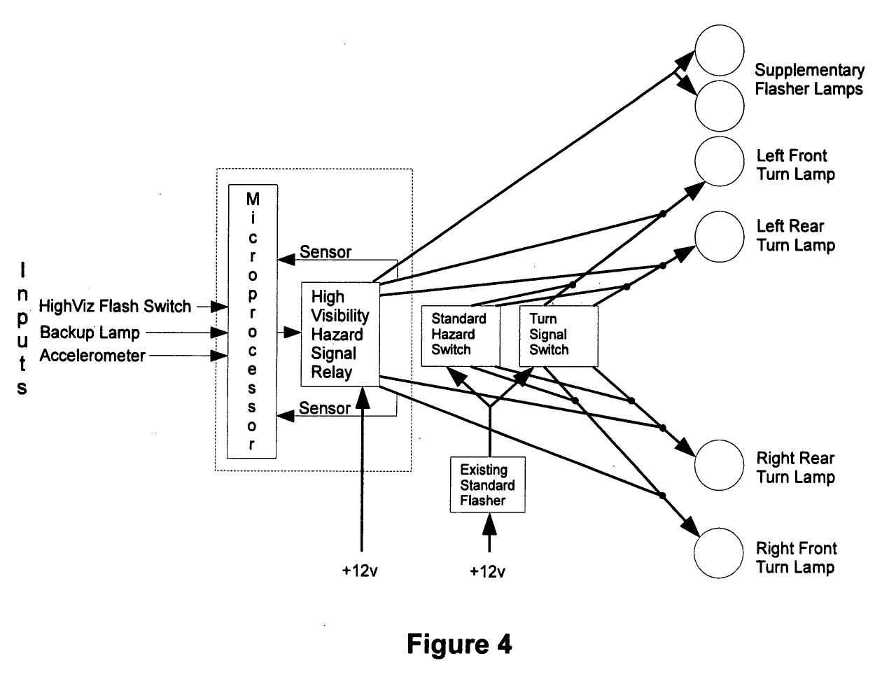

### FIG. 4—Flasher Unit Version E

Version E is identical to Version D with one addition. By separate wiring from the flasher, the same auxiliary High-Visibility Flash hazard signals are produced synchronously in Supplementary Flasher Lamps as are displayed in the turn signal lamps. Supplementary Flasher Lamps produce only the auxiliary High-Visibility Flash hazard signal, not turn signals or standard hazard signals. The Supplementary Flasher Lamps would be added to give greater display than that provided by auxiliary High-Visibility Flash hazard signals in the turn signal lamps alone. The supplementary flasher lamps can be permanently affixed to any vehicle or can be lamps temporarily attached to a vehicle to produce the auxiliary High-Visibility Flash hazard signal in the Supplementary Flasher Lamps synchronously with the turn signal lamps. Activation of a turn signal would cancel the auxiliary High-Visibility Flash hazard signal in the supplementary flasher lamps and in the turn signal lamps.

Supplementary flasher lamps as described here can also be added to Version C.

What is claimed is:

1. A hazard warning flasher, which makes it possible, at the drivers selection, by means of a manual switch, for motor vehicles to use the vehicle's turn signal lamps to produce either of two hazard warning flash patterns:
a. A standard, turn-signal-like hazard flash;
b. An alternative or auxiliary hazard flash with a different flash pattern and/or rate of flash.

2. A hazard warning flasher, which makes it possible, at the drivers selection, by means of a manual switch, for motor vehicles to use the vehicle's turn signal lamps to produce either of two hazard warning flash patterns:
a. A standard, turn-signal-like hazard flash;
b. An auxiliary hazard warning signal consisting of a High-Visibility rapid, pulsating flash, as described in my U.S. Pat. No. 6,515,584 B2.

3. A flasher for motor vehicles, which provides in supplementary lamps only one signal, an auxiliary hazard warning signal synchronous with that being displayed in the vehicle's turn signal lamps, said auxiliary hazard warning signal being distinctive from a turn signal flash pattern, said supplementary lamps being permanently affixed or temporarily attached to the vehicle.

4. A flasher for motor vehicles, which provides in supplementary lamps only one signal, an auxiliary hazard warning signal synchronous with an auxiliary hazard warning signal being displayed in the vehicle's turn signal lamps, said auxiliary hazard warning signal being the same High-Visibility, rapid, pulsating flash described in my U.S. Pat. No. 6,515,584 B2, said supplementary lamps being permanently affixed or temporarily attached to the vehicle.

5. A hazard warning flasher for motor vehicles, which automatically cancels the hazard warning signal when the operator activates a turn signal, said hazard warning signal being displayed in the vehicle's turn signal lamps.

6. A hazard warning flasher for motor vehicles, which automatically cancels the hazard warning signal when the operator activates a turn signal, said cancellation effected by means of a microprocessor sensing that a flash pattern has been activated which is different in timing from the flash pattern of the hazard warning signal, said hazard warning signal being displayed in the vehicle's turn signal lamps.

7. A hazard warning flasher for motor vehicles, which flasher does not provide turn signals or conventional hazard warning signals, and which provides an auxiliary hazard warning signal which is distinctive from turn signals, said auxiliary hazard warning signal being displayed in the vehicle's turn signal lamps and optionally displayed in supplementary flasher lamps, which flash synchronously with said auxiliary hazard warning signal in turn signal lamps.

8. A hazard warning flasher for motor vehicles, which flasher does not provide turn signals or conventional hazard warning signals, and which provides an auxiliary hazard warning signal consisting of a High-Visibility rapid, pulsating flash, as described in my U.S. Pat. No. 6,515,584 B2, said auxiliary hazard warning signal being displayed in the vehicle's turn signal lamps and optionally displayed in supplementary flasher lamps, which flash synchronously with said auxiliary hazard warning signal in turn signal lamps.

9. A flasher for motor vehicles, which automatically produces a hazard warning signal while the vehicle is shifted into reverse gear, said hazard warning signal being displayed in the vehicle's turn signal lamps and optionally displayed in supplementary flasher lamps, which flash synchronously with said auxiliary hazard warning signal in turn signal lamps.

10. A flasher for motor vehicles, which automatically produces an auxiliary hazard warning signal while the vehicle is shifted into reverse gear, said auxiliary hazard warning signal being the same High-Visibility rapid, pulsating flash described in my U.S. Pat. No. 6,515,584 B2, said auxiliary hazard warning signal displayed in the vehicle's turn signal lamps and optionally displayed in supplementary flasher lamps, which flash synchronously with said auxiliary hazard warning signal in turn signal lamps.

11. A flasher for motor vehicles, which automatically produces an auxiliary hazard warning signal when the vehicle decelerates rapidly, said auxiliary hazard warning signal being the same High-Visibility rapid, pulsating flash described in my U.S. Pat. No. 6,515,584 B2, said auxiliary hazard warning signal being displayed in the vehicle's turn signal lamps and optionally displayed in supplementary flasher lamps, which flash synchronously with said auxiliary hazard warning signal in turn signal lamps.

12. A hazard warning flasher for motor vehicles, which provides one specific auxiliary hazard warning signal, which auxiliary hazard warning signal is distinctive from turn signals and is the identical flash pattern for the following three different categories of hazard:
a. A manually initiated signal for a hazard perceived by the driver;
b. A signal that the vehicle is about to back up or is backing, the signal initiated automatically while the vehicle is shifted into reverse;
c. A signal that the vehicle is rapidly decelerating, the signal automatically initiated by an accelerometer;
said auxiliary hazard warning signal being displayed in the vehicle's turn signal lamps and optionally displayed in supplementary flasher lamps, which flash synchronously with said auxiliary hazard warning signal in turn signal lamps.

13. A hazard warning flasher for motor vehicles, which provides one specific auxiliary hazard warning signal, which auxiliary hazard warning signal is distinctive from turn signals, said auxiliary hazard warning signal being the same High-Visibility, rapid, pulsating flash described in my U.S. Pat. No. 6,515,584 B2 for the following three different categories of hazard:
a. A manually initiated signal for a hazard perceived by the driver;
b. A signal that the vehicle is about to back up or is backing, the signal initiated automatically while the vehicle is shifted into reverse;
c. A signal that the vehicle is rapidly decelerating, the signal automatically initiated by an accelerometer;
said auxiliary hazard warning signal being displayed in the vehicle's turn signal lamps and optionally displayed in supplementary flasher lamps, which flash synchronously with said auxiliary hazard warning signal in turn signal lamps.

14. A flasher control device which provides an auxiliary hazard warning signal displayed in the turn signal lamps of a vehicle, said auxiliary hazard warning signal being distinctive in comparison to the flash patterns and timing of turn signals and standard hazard signals.

15. A flasher control device which provides an auxiliary hazard warning signal displayed in the turn signal lamps of a vehicle, said auxiliary hazard warning signal being distinctive in comparison to the flash patterns and timing of turn signals and standard hazard signals, said auxiliary hazard warning signal being the same High-Visibility, rapid, pulsating flash described in my U.S. Pat. No. 6,515,584 B2.
